(19) United States
(12) Patent Application Publication
(10) Pub. No.: US 2006/0064317 A1
(43) Pub. Date: Mar. 23, 2006

(54) Extended work program

(75) Inventors: Anatoly Feygenson, Hillsborough, NJ (US); Mark S. Popolano, Warren, NJ (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: American International Group, Inc., New York, NY (US)

(21) Appl. No.: 11/273,459

(22) Filed: Nov. 14, 2005

Related U.S. Application Data
(62) Division of application No. 10/753,270, filed on Jan. 8, 2004.

(51) Int. Cl. G06Q 99/00; G05B 19/418

(52) U.S. Cl. 705/1; 705/8; 705/9

(57) ABSTRACT

An extended work program (EWP) is provided in which unemployed and under-employed workers perform atomic units of work. The inventive system and method includes an administrative system, employer systems and participant systems, each of which communicates over the Internet. Employers locate EWP participants by querying an administrative system, which provides information regarding a pool of participants and further announces the available work to the pool. After suitable candidates are located, the administrative system, in conjunction with the employers' systems, trains, evaluates, and compensates EWP participants on an atomic unit of work basis. The participants communicate, in a human-centric trusted computing environment, with the employers through the administrative system.

### FIELD OF THE INVENTION

The present invention relates to an Extended Work Program (EWP) that uses the Internet to identify, employ, manage (including testing, training and evaluation) and compensate workers in a distributed environment. The preferred embodiment of an EWP has particular applicability to unemployed or under-employed workers, who collectively represent a vast untapped labor resource pool.

An EWP creates fundamentally different relationships between potential workers and job providers than the traditional employer/employee relationship. Participants in an EWP are not necessarily known to potential employers, and instead provide services on an anonymous or semi-anonymous basis. Employers may consume the services provided by such participants on a predetermined basis. The employers and participants make contact with each other via an independent Administrative System, which facilitates the training, evaluation, and compensation aspects of the employer/participant relationship. The EWP approach, in contrast to the conventional model, thus frees the employer and participant from certain inefficient and time-consuming interactions and/or transactions that are usually required between them. The employer does not administer payroll, benefits and taxes, among other things, and the participant is able to determine the most convenient work hours and work locations.

In an EWP, unemployed or underemployed workers may perform operations that are known as “atomic units of work.” Examples of atomic units of work include reviewing documents for typographical information, processing insurance claims, processing accounts payable, writing software modules, designing circuit components, completing proposals, etc. The atomic unit of work approach contrasts with the prevailing hourly wage approach used throughout most industries. A participant in the EWP has freedom to choose work-hours, geographical location, and type of atomic units of work.

The use of the Internet to recruit individuals as employees is well known. Internet sites, such as www.monster.com and www.hotobs.com, offer prospective employees and employers an opportunity to post job offers and resumes. In such applications, the employer posts an opening for a position, which is published to the site, and potential job applicants may view the opening and submit a resume for the employer's consideration. This approach, however, facilitates only a conventional employment arrangement.

Likewise, other prior art employment systems based on the Internet focus on satisfying employers' conventional hiring needs. These systems do little to tap into the unemployed or under-employed labor pool to fill employers' needs on a dynamic basis. For example, employers hire employees to perform tasks or provide services, but an employers' need for employees may vary from time to time. The conventional employment model does not provide an optimal level of staffing because there is typically a time lag between the hiring or firing of employees and the need for such employees. Similarly, many individuals that are otherwise capable of performing tasks are not desirable candidates to employers because, among other things, such individuals may have limitations on schedule or proximity to the employer.

The current invention permits employers to use the unique communication capabilities of the Internet to employ suitable candidates to perform atomic units of work, and, through the use of an Administrative System, further offers such employers the ability to screen and employ participants without necessarily entering into inefficient and unnecessary communications and transactions with the workers. The EWP approach solves common problems that are not resolved through the use of the conventional employment model.

### SUMMARY OF TE INVENTION

A system and method for implementing an EWP includes some or all of the following phases: annunciation, search, screening, training, evaluation, active participation, and performance tracking. In a preferred embodiment, the system and method for implementing an EWP involves atomic units of work. Atomic units of work may be defined as activities that a business could not, or would not for practical reasons, further subdivide. Examples of atomic units of work include reviewing documents for typographical information, processing insurance claims, processing accounts payable, writing software modules, designing circuit components, completing proposals, etc.

The annunciation phase of the EWP includes, for example, an announcement that a firm or business needs a particular type of atomic unit of work performed. Such an announcement may be made over a centralized publishing mechanism, such as an Internet site, or in a person-to-person way. Information regarding the pool of available workers may be maintained in a knowledge base by an Administrative System. In one embodiment, the Administrative System does not maintain personal information, such as names and social security numbers. The knowledge base typically contains information as to the ability of each potential worker to perform various types of atomic units of work, the work history of each potential worker, and/or rankings of each potential worker relevant to other workers in regard to particular types of atomic units of work.

The search phase of an EWP will typically be performed by employers looking to quickly identify skills available in the EWP labor pool. The search can be performed in a broadcast mode, where a need for participants is announced to the entire pool. Alternatively, in directed search mode, announcements are sent only to potential participants that meet established criteria, for example, educational level, job preference, ranking, etc.

In the screening phase, a firm or business that requires additional screening criteria beyond what is available in the knowledge base may solicit information from workers in the pool of available talent. Additional screening can be performed to verify information such as educational credentials, job experience, security clearance, and/or references.

The training phase begins when successful candidates have been found and/or pre-screened. A business or firm, for example, may conduct any or all of the following training activities: (a) instruct the selected candidate how to perform the required type of atomic units of work, which instructions may be communicated over the Internet on a screen-by-screen basis; (b) conduct a performance test that closely resembles a real job; (c) provide feedback to the candidate regarding test results with areas of improvement ranked by importance and overall test score; and (d) offer a choice of taking additional training and testing to improve the candidate's relative ranking.

In the evaluation phase, the firm or business reviews the qualifications of candidates, including any ranking or evaluation based on the test score achieved during the training phase. The firm or business may select candidates that have met or exceeded a required performance minimum.

In the active participation phase, the selected candidate performs the required atomic units of work. It is expected that the selected candidate will meet or exceed all relevant performance metrics. In the event that performance falls outside an established norm, a participant may be given an opportunity to undergo additional training and re-join the program. An Administrative System tracks the completed atomic units of work and performs necessary payroll functions in accordance with negotiated or otherwise predetermined rates.

The performance tracking phase begins when the firm or business determines the quality of the atomic units of work performed by each candidate. The “quality” may be determined through the use of critical quality and performance metrics, such as the number of customer complaints and/or number of defects (errors) in processed documents. The data collected as part of the performance tracking phase may be reported to the knowledge base. In addition, the firm or business may inform a participant that the quality of work is deficient.

All communications between an EWP participant and employer may be handled via the Administrative System, as opposed to direct communications with the participant.

This indirect communication channel facilitates privacy protection and dispute resolution.

In addition, it is contemplated that various security measures will be used to authenticate and verify participants and work products. Examples of such security measures include trusted computing and biometric data.

### BRIEF DESCRIPTION OF THE DRAWINGS

Exemplary embodiments of the invention are given below with reference to the drawings, in which:

FIG. 1 is a block diagram generally illustrating the relationship between employers, participants, an Administrative System and the Internet;

FIG. 2 is a schematic diagram of the Administrative System;

FIG. 3 is a logical representation of the data as stored in the Administrative System;

FIG. 4 is a block diagram of the manner in which certain components of an employer's system may be configured;

FIG. 5 is a diagram illustrating a trusted computing environment; and

FIG. 6A, FIG. 6B, and FIG. 6C are flowcharts illustrating processes associated with an EWP.

### DETAILED DESCRIPTION OF PREFERRED EMBODIMENTS

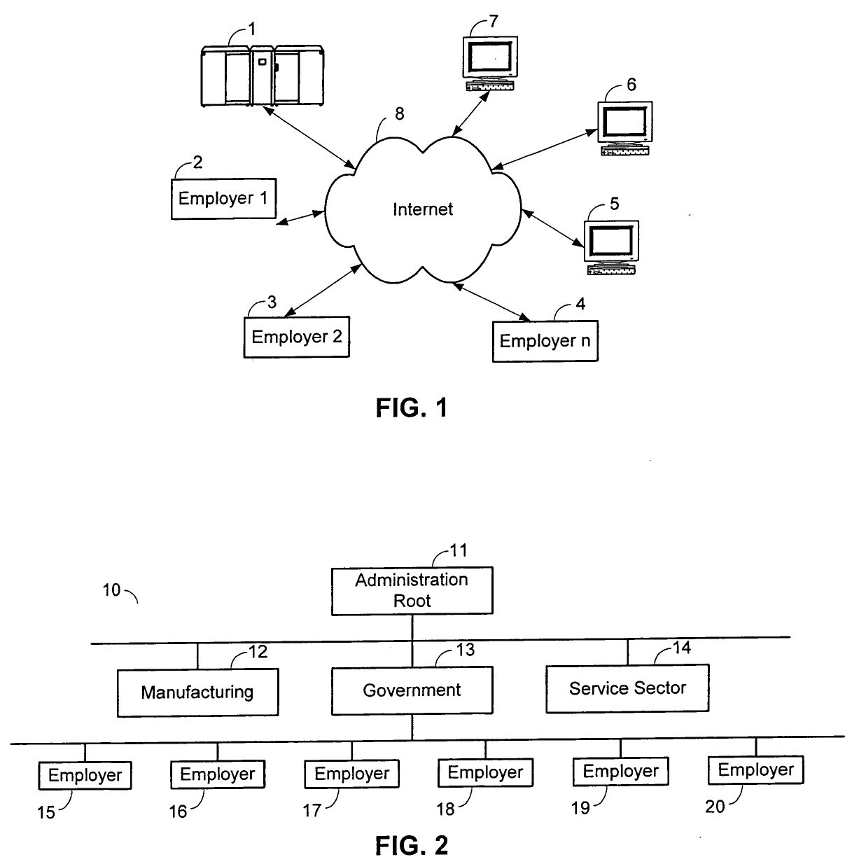

An EWP permits the recruiting and employment of unemployed or under-employed workers in a distributed environment. The architecture of a preferred EWP for efficiently accessing, engaging and managing human resources is illustrated in FIG. 1.

The Internet 8 connects an Administrative System 1, a plurality of employer systems 2-4, labeled Employer 1 through Employer n, and a plurality of computer systems 5-7 for potential workers (“participants”). It will be appreciated that FIG. 1 is a representative illustration only and is not a limitation on the number of employers or participants. It is expected that implementations of EWPs potentially may involve millions of participants.

The Administrative System 1 maintains a knowledge base that may hold information about participants, such as addresses, social security numbers, dates of birth, genders, resumes, prior employment records, and the like. In addition, the Administrative System 1 may contain security clearance information, drug test results, legal compliance information, personal and employment references, and other types of highly privileged data. The Administrative System 1 further manages the communications between employer and participant as well as the compensation of participants for the performance of atomic units of work and/or other activities. As such, the Administrative System 1 also will typically hold information about the employers registered with it. The Administrative System 1, however, will not typically contain information regarding employers' work systems and jobs. This type of information is instead maintained on the employers' systems 2-4.

Employers' systems in a preferred embodiment, such as systems 2-4, will not hold private participant's data, thus providing separation between the participant and employer. Each of the employers' systems, however, will contain performance-related information gathered during the employment process, such as the number and type of atomic units of work performed and the quality of the work performed. Participants can be remotely located from one or both of the Administrative System 1 and/or employers' systems 2-4, and are connected via the Internet 8.

In a preferred embodiment, it is contemplated that employers' systems will identify and communicate with participants via a Unique Participant Identifier (UPI), and not by name or social security number. In this manner, employers may maintain separation from EWP participants. Each UPI is generated by the Administrative System 1 during initial participant registration. In a preferred embodiment, UPIs represent a combination of data supplied by both the participant and the Administrative System 1. As one example, each participant's UPI may contain eight participant-selected alphanumeric elements and four alphanumeric elements added by the Administrative System according to a hashing algorithm. This UPI construction technique will guarantee uniqueness and easy validation of a UPI, similar to that in credit cards.

Each participant is not restricted to a single UPI. Because participants may be working for numerous different employers, multiple UPIs will better protect each participant's identity. In addition, multiple UPIs are preferred because a participant may work for the same employer in multiple occupations. The use of multiple UPIs prevents an employer from recognizing this fact and thereby prevents potential bias or favoritism against individual participants. In a typical application, the participant will determine the number of UPIs to use.

Importantly, the Administrative System 1, which is illustrated as a unitary system, may be either a single system or a scalable, distributed system. In a scalable, distributed environment, multiple systems, such as those maintained by national governments, states, local authorities and/or private enterprises, may communicate with each other to accomplish the objectives of the Administrative System 1. Any one of these entities can delegate control to their designated surrogates. However, they all must be able to hold and protect private participant data.

The Administrative System 1, therefore, is a platform independent system and may be deployed on any suitable computing system (or systems) that is capable of accomplishing the objectives described above, e.g., maintaining a knowledge base with participant data, handling announcements of available work, tracking completed atomic units of work, and ensuring compensation for completed atomic units of work. The Administrative System 1 further may provide for simple dispute resolution procedures. In general, the Administrative System 1 should have fail-over and redundancy capabilities to ensure that the system continues to operate even in the event of non-critical failures. The Administrative System 1 also should be scalable to accommodate large number of participants, e.g., millions of participants, as well as the data associated with such participants.

In this regard, at least portions of a preferred embodiment of the Administrative System are similar in nature to the Domain Naming System (DNS) of the Internet, and may be comprised of many subsystems that insure reliability of service and propagation of information. Multiple servers within the Administrative System 1 may contain information about domains and sub-domains within the entire system. Requests for access to information in a sub-domain can be passed by a higher level domain server to a server for the relevant sub-domain. In this way, the Administrative System is distributed across many systems, and possibly across the Internet, with each domain or sub-domain maintaining only pertinent information.

FIG. 2 is a schematic diagram of a preferred embodiment of an Administrative System 1, which is generally indicated as reference numeral 10. The system is hierarchical in nature and includes several domains. The domains include a root level domain 11, industry domains, such as those illustrated at reference numerals 12-14, and employer domains, such as those illustrated at reference numerals 15-20. Although only three domains are indicated, additional domains and/or sub-domains may be used as necessary. For example, a participant domain also may be added to the hierarchy below the employer domain.

The root level domain 11 maintains private data associated with participants, such as identity and compensation history. Industry domains 12-14 hold employer-related data, such as the industry to which each employer belongs, the identity of each employer, and the Internet URL for each employer. Employer domains 15-20 hold each participant's historical job-related data but not private data. Such job-related data may include descriptions of the various completed atomic units of work, the duration of any prior participation in the EWP, and quality of performance.

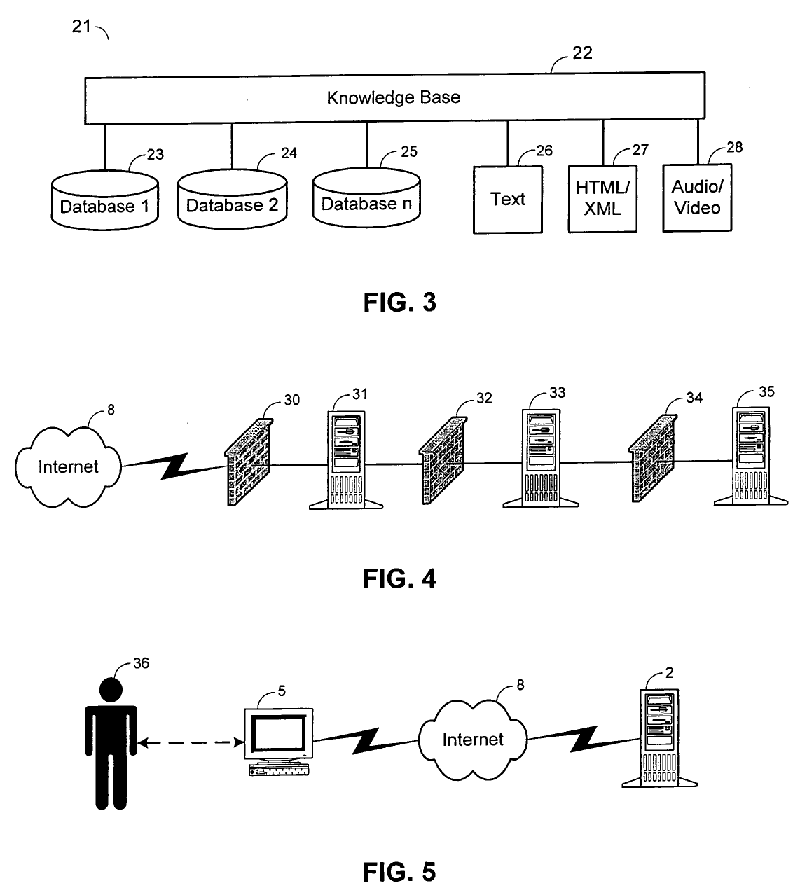

FIG. 3 provides a logical representation of data storage in the Administrative System 1. The knowledge base of the Administrative System 1, which is spread across multiple domains, combines information sources of structured data, such as in relational databases 23-25, as well as unstructured data typically found on the Internet, such as web pages, video/audio clips, and even flat files 26-28.

An example of an employer's system (reference numerals 2-4 in FIG. 1) is illustrated in FIG. 4. In this example, the employer's business application represents a multi-tiered design separated by security firewalls 30, 32 and 34. The employer's data is typically kept in a database server 35 residing on internal network. The employer's system may further include an application server 33 that contains business logic and business rules and further connects to the database server 35 via an internal network. In addition, a web server 31 provides connectivity to the Internet and further provides an interface to participants. The web server 31 connects to the application server 33 through a firewall, formats application's data into a user-friendly presentation, and then delivers this presentation through the external firewall to the Internet 8.

An example of a participant's system, such as those indicated by reference numerals 5-7 in FIG. 1, is further illustrated in FIG. 5. The participant system 5 may or may not be owned by the participant, but should be readily accessible to such participant. In a preferred embodiment, it is contemplated that the participants' system will require only standard browser software, such as Microsoft Corporation's Internet Explorer, which is found on most PCs, laptop computers, PDAs, cell phones, etc. It is possible, however, that additional application software may be downloaded or otherwise supplied to the participant's systems to enable a participant to complete atomic units of work. Participant system 5 connects via the Internet 8 to the employers' web-enabled applications. In addition, the participant system must connect to the Administrative System 1 directly (not shown) and to the employer's system 2.

In one preferred embodiment of the invention, it is desirable that a high level of trust be established between a participant, the participant's system, the employers' systems and the Administrative System 1. This trust is illustrated in FIG. 5 as a dashed line between participant 36 and participant's system 5. In this embodiment, the level of trust is established through a human-centric trusted computing environment. A higher level of trust, such as that of a human-centric trusted computing environment, is required in this embodiment because there is no traditional supervision of the employee. This embodiment further includes security that protects data transmissions between participant, employer and the Administrative System through authentication, authorization, encryption and audit trails.

An EWP participant's identity may be verified through the use of devices, such as wearable badges, that ensure that the participant is actually the individual associated with a specific UPI. Such devices include continuous verification of the relationship between participant and a “trusted” computer. Examples of such devices include those that correlate unique biometric data with an individual, such as a participant's heart-beat and blood pressure and on the job performance. One example of a biometric authentication system is described more fully in U.S. Pat. No. 5,719,950 to Osten et al., the disclosure of which is incorporated by reference. In addition, other devices include hardware-based security encoders, short-range wireless operation via infrared or RF Global Positioning System (GPS) receivers with altimeter, and spread-spectrum-based transmitter/receiver modules to secure wireless transmission. In a preferred embodiment of the invention, continuous or semi-continuous verification of the user with biometric data also establishes the required level of trust. Examples of the latter types of systems are described more fully in U.S. Pat. No. 5,229,764 to Matchett et al. and U.S. Pat. No. 6,539,380 B1 to Moran, the disclosures of which are incorporated by reference. Depending on the level of trust established, the participant may engage in more or fewer activities within the EWP system.

A human-centric “trusted computing” environment is thus an important aspect of one embodiment of the EWP. In this embodiment, both the environment of an EWP participant's system and a device itself will comply with the standards set by the Trusted Computing Platform Alliance. In addition, it is possible to correlate a specific device with data relating to job performance, such as the time required to perform a specific atomic unit of work.

In the event that a physical badge is issued as part of the trusted computing environment, it is contemplated that such badge will be associated with at least one Unique Participant Identifier of the participant. It is further contemplated that the badge may contain job-related data accessible to the employer as well as private data such as a picture, medical, insurance and other privileged information that is not otherwise accessible to employer.

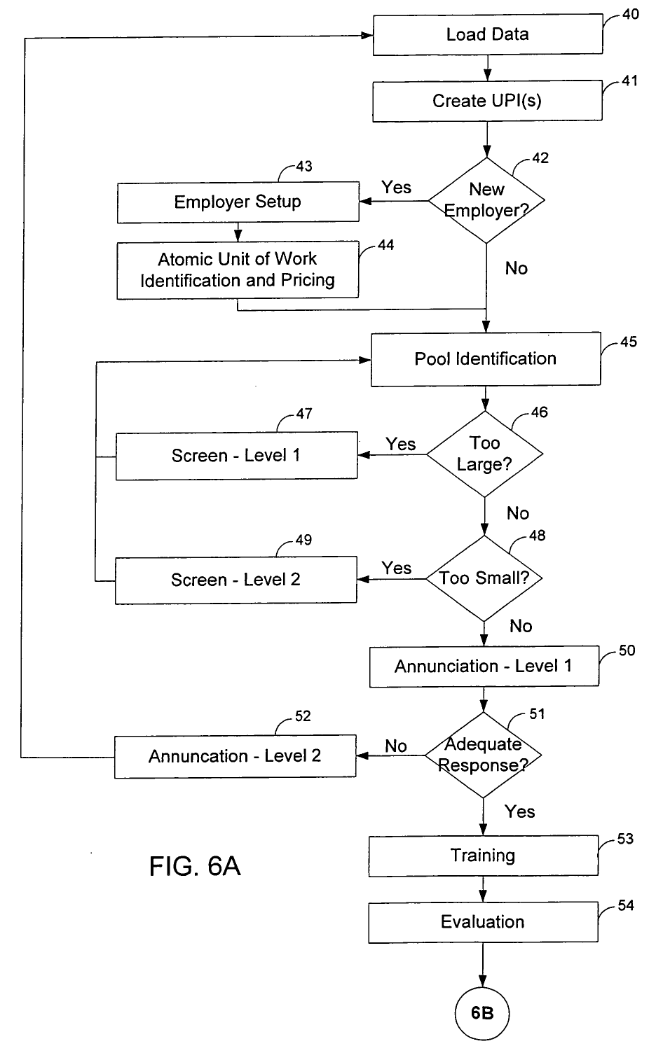

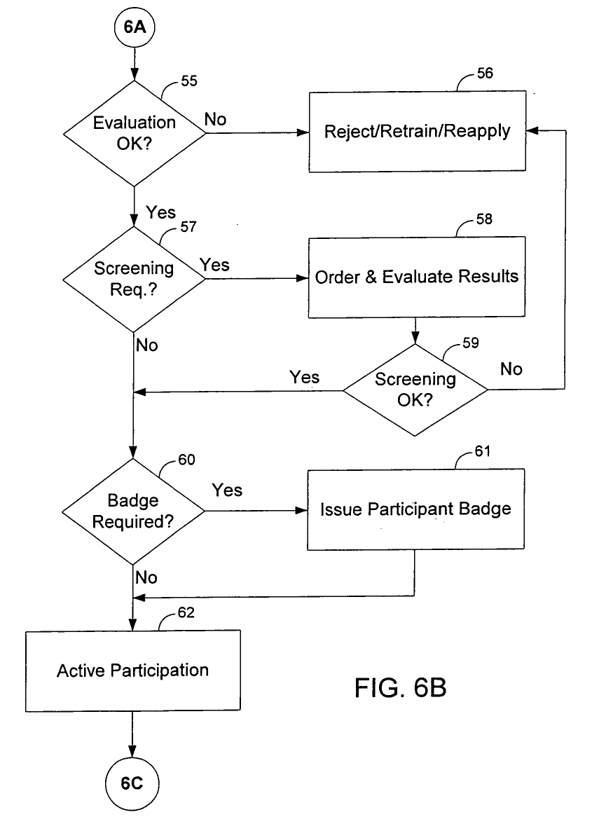

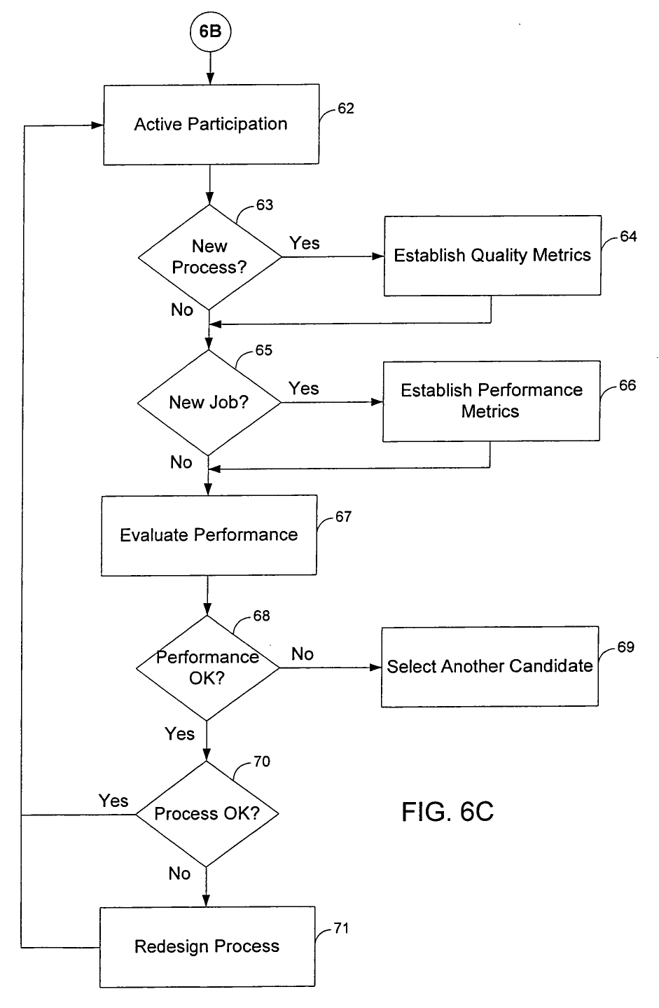

The process by which the EWP may be implemented is generally illustrated in FIGS. 6A-6C. The process makes no assumptions that a qualified participant exists; it also reverses a conventional employment process where an employer receives a notification from a prospective employee in either a conventional setting or over the Internet. Although FIGS. 6A-6C illustrate certain steps that may be useful in implementing an EWP in accordance with a preferred embodiment of the invention, not all of the steps are required. FIGS. 6A-6C are meant to be illustrative only and should not be taken as limiting the scope of invention. Those of skill in the art will recognize that certain steps can be modified in arrangement and detail without departing from the spirit of the invention.

The first step in the process is to load the knowledge base of Administrative System 1 with pertinent private data, as indicated by reference numeral 40. Such private data may include, for example, an employment history or resume from an unemployment office, an on-line application, or any other source that collects information regarding unemployed or under-employed workers. The Administrative System 1 loads data on a regular basis or may collect data in real time, such as when a potential EWP participant applies for a UPI.

The Administrative System next creates a UPI, as illustrated at step 41. The UPI is an alias that is used in lieu of traditional private data, such as the EWP participant's name or social security number, and thereby provides a screen between potential employers and an EWP participant. Information relating to the participant's employment history, however, is not considered “private.” Instead, attributes such as education, employment history, etc. are made available in the knowledge base for subsequent searching by potential employers.

Each employer that wishes to access the EWP must also setup an account on the Administrative System 1, as illustrated in steps 43-44. If the employer has already established an account, these set-up steps may be bypassed, as indicated by decision 42. The setup process 43 includes the employer's registration with a required ID and other relevant information. In addition, the employer must establish with the Administrative System an electronic funds transfer account or other assurance of payment for work completed by EWP participants.

The employer must further identify an “atomic unit of work” which is used as a basis to calculate pay, step 44. The Administrative System 1 tracks performed atomic units of work by participants and also calculates payment to participants in accordance with a posted pay scale, which may be expressed as amount of pay divided by units of finished work. This approach differs, for example, from the traditional hourly rate of work. An hourly rate is thus not used as a basis for payment except for those situations, such as when a participant must be available for work, in which case time is a surrogate for an atomic unit of work.

The pay scale established in step 44 may be negotiable or non-negotiable depending on various factors, including the availability of qualified participants. For example, if many qualified participants are available to perform the required atomic units of work, the payment for such work is unlikely to be negotiated. If fewer qualified participants are available, however, the employer may set a range of compensation or invite each qualified participant to quote a rate for which such participant will complete the atomic units of work.

Atomic units of work, as described above, may be defined as activities that a business could not, or would not for practical reasons, further subdivide. Examples of atomic units of work include reviewing documents for typographical information, processing insurance claims, processing accounts payable, writing software modules, designing circuit components, completing proposals, etc. An employer will typically identify an atomic unit of work by breaking down large projects into smaller projects in an iterative manner until the smallest practical unit of work is identified. Readily separated small projects, by themselves, may be acceptable atomic units of work. Atomic units of work should be independent and quantized such that no two business activities interfere with each other. In addition, each atomic unit of work should not make performance of another atomic unit of work more difficult to perform.

After the Administrative System 1 has loaded employer and participant data, an employer may begin to use the system to identify a pool of prospective EWP participants, step 45. The employer may perform a targeted search or a “proximity” search of the knowledge base. In a targeted search the employer will attempt to identify potential participants based on the exact qualifications required to perform certain atomic units of work Alternatively, an employer may conduct a proximity search, e.g., one that includes education level, prior occupation and employment history, which can produce a more complete result set. The proximity search, therefore, is a search for potential participants that is undertaken when a potential employer recognizes that an exact match for a participant is either unlikely or unneeded. For example, insurance companies may find that former airline pilots succeed as insurance underwriters because both jobs require greater attention to details and self-control. A proximity search for insurance underwriters may reveal former airline pilots, whereas a targeted search for only insurance underwriters rnay result in a much smaller pool of available participants.

As indicated by decision 46, an employer next considers whether the result set is too large. If yes, the employer may perform an additional screening of the results with more stringent requirements to reduce the pool's size, step 47. If the result set is too small, as indicated by a “yes” at decision 48, the employer may perform an additional screening of the results with less stringent requirements to increase the pool's size, step 49. These steps are repeated until a suitable pool of potential participants has been determined. As an alternative to steps 42 through 45, an employer may conduct a search in broadcast mode, where the need for participants to perform certain atomic units of work is announced to an entire pool.

Next, at step 50, the Administrative System 1 announces a message to the pool of potential participants that they have met initial qualifications. The annunciation includes, if necessary, an invitation to complete online training to perform the required atomic units of work. The annunciation may be performed in a direct manner in which each candidate gets an identical message or may be performed via a “small-world” message delivery with a combination of clustering/de-clustering techniques. In the latter approach, the announcement is made only to selected prospective participants, which may accept the opportunity and/or pass the opportunity to other prospective candidates. It is understood, as an empirical matter, that prospective candidates having certain qualifications will comprise a network of individuals that are positioned to identify other highly desirable candidates. The “small-world” delivery system thus may yield more productive results than a direct message delivery.

After announcing the need for potential participants, the employer determines at decision 51 whether a sufficient number of qualified participants have responded. If not, a further annunciation, step 52, may be required. This step, identified in the flow chart of FIG. 6A as “Annunciation—Level 2,” preferably would involve a “small world” message delivery or an additional targeted message. Additional candidates, identified with the second level annunciation step, may be required to register with the Administrative System 1 before being considered for the next step.

After a suitable number of qualified participants willing to perform the atomic units of work have been located, the next step, step 53, is to provide online training. Training may or may not be required depending on whether a participant has previously performed the specific type of atomic unit of work. In the event that training is required, it will typically consist of exhaustive screen-by-screen instructions related to performing the atomic units of work, which instructions the employer delivers via the Internet.

In the usual situation, there are no time limits placed on the duration and availability of training. In certain situations, however, time is of the essence, and training will be available only for a short period of time. A prospective participant may receive training as many times as necessary or for as long as the participant desires in order to learn to perform the required atomic units of work. In addition, a prospective participant may train for many different types of atomic units of work, thereby permitting a single person to perform multiple different roles for a single employer or the same role for different employers.

After the applicant has completed training, the next step in the process, step 54, is the evaluation of the participant's fitness to perform the atomic units work. The initial evaluation is based on a test score achieved at the completion of training. A performance test that closely resembles a real job is administered at the conclusion of the training phase, typically in an automated manner by the employer's system, and detailed test results are generated. The results may include areas of improvement ranked by importance and overall test score.

Turning to FIG. 6B, the employer determines at decision 55 whether the test results of a potential EWP participant are acceptable. If the evaluation is not acceptable, the prospective participant is rejected and/or offered an opportunity for additional training and to reapply upon completion of such training, step 56. A test score that meets or exceeds the required minimum establishes that the prospective participant is qualified to perform the atomic units of work. If more than the needed number of participants qualifies under the evaluation at decision 55, the employer may increase the requirements for the position and/or select only those participants with the highest test scores.

After a participant has qualified to perform the atomic units of work, the employer must then determine, at decision 57, whether additional screening of the participant is required. This would be the case if a security clearance, drug testing, background checks, etc. are required for the job. In order to ensure the participant's privacy, additional screening may be performed by the Administrative System. The employer, however, would bear the responsibility to evaluate the results and suggest training for another job with less stringent requirements if screening is not satisfactory. If the applicant does not satisfy the screening requirements, the applicant is again rejected and/or invited to apply for a different job, step 56.

If the applicant qualifies for the position and satisfies the screening requirement, the employer must then determine the level of trust that must be established between the participant and the employer. This is indicated at decision 60, which is labeled for convenience as a decision involving a “badge.” As noted above, a high level of trust may be established by physical devices, such as a badge, that monitor biometric data or otherwise provide a level of assurance that the participant is actually the person she or he purports to be. In the event that a “badge” is required, it is issued in step 61.

At this point in the process, the applicant begins the active participation phase, step 62. During active participation, the employer and/or the Administrative System 1 continuously evaluate the performance of the participant. The Administrative System 1 tracks the number of performed atomic units of work, calculates participant's pay, and actually pays the participant. In addition, the Administrative System 1 withholds appropriate taxes and issues a paycheck, either physical or electronic. All administrative communications between participant and employer are handled via the Administrative System 1. This indirect communication channel facilitates privacy protection and dispute resolution.

Turning to FIG. 6C, it is noted that the EWP process of a preferred embodiment includes tracking a participant's performance. This tracking process includes the use of quality monitoring and improvement loop. In the event that the process of performing the relevant atomic units of work is new, as indicated by a “yes” at decision 63, or if the job itself is new, as indicated by a “yes” at decision 65, it is necessary to establish the relevant quality and performance “metrics,” as indicated by steps 64 and 66 respectively. Such metrics may include an identification of critical quality considerations—such as the number of customer complaints, and/or number of defects (errors) in processed documents—and an identification of critical performance considerations—such as the time to complete each atomic unit of work.

After establishing the appropriate metrics, the employer may then analyze the performance of each active participant, as indicated in step 67. Based on data collected in this step, it is possible for the employer to implement statistical process controls, such as the six-sigma method, in order to reduce repetitive errors associated with a participants' performance. It is also possible to establish metrics that evaluate the objective performance of one participant versus all other participants.

In the event that an EVVP participant fails to perform up to expectation, as indicated by a “no” in decision 68, the employer may select another candidate to perform the atomic units of work, as indicated by step 69. As with rejected prospective participants, a rejected participant may be invited to retrain and/or reapply, as indicated at step 56. If the performance is acceptable, as indicated by a “yes” in decision 68, the participant continues to perform the atomic units of work.

From time to time, an employer also may consider whether the process of performing the atomic units of work is satisfactory, as indicated by decision 70. If an analysis demonstrates that a quality and/or performance problem exists that cannot be bridged through a selection process, it may be necessary to redesign the process. In this event, it will be necessary to establish new metrics associated with the new process, and to reevaluate the performance of the participants in the new process. In the event of a redesigned process, it also may be necessary to begin the entire process again at step 40. The processes of identifying and selecting participants, as well as establishing atomic units of work, are such that they will be continually improved over time.

To maintain active status, an employer may require that a participant meet or exceed norms as to the quality and performance of past, present and overall atomic units of work. In the event that performance exceeds the established norms by a predetermined amount, the employer further may provide the participant with an increased pay scale and/or a bonus. In the event that performance falls outside established norm, the participant is given an option to undergo additional training and re-join the employment. The evaluation continues in real time with performance modes evaluated through the use of feedback techniques.

While this invention has been described with an emphasis upon particular embodiments, it should be understood that the foregoing description has been limited to the presently contemplated best mode for practicing the invention. It will be apparent that various modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

1. A method for efficiently accessing, engaging and managing human resources, the method comprising the steps of:
identifying a task that must be performed;
dividing the task into types of atomic unit of work that can be performed by persons with specialized training;
determining a payment for each atomic unit of work of the identified type;
identifying candidates capable of performing the type of atomic unit of work by consulting a knowledge-base, which includes data that (a) uniquely identifies each candidate, (b) indicates the qualifications of each candidate, (c) indicates an assessment of each candidate's ability to perform the type of atomic unit of work relative to other candidates' ability to perform the same type of atomic unit of work; and (d) indicates the quality of actual performance of atomic units of work if the candidate has previously performed such atomic units of work;
selecting at least one of the identified candidates to perform atomic units of work of the identified type;
paying the selected candidate the determined payment for each performed atomic unit of work of the identified type.

2. The method of claim 1 further comprising the step of determining an assessment of the quality of performance of the atomic units of work by the selected candidate.

3. The method of claim 2, wherein the step of determining an assessment includes the step of comparing the performance of the atomic units of work by the selected candidate against an objective criterion.

4. The method of claim 3, wherein the step of comparing includes comparing the timeliness of the performance of the atomic units of work by the selected candidate against predetermined deadlines for performance.

5. The method of claim 3 further comprising the step of adding data to the knowledge-base that is indicative of the determined assessment of the performance of the selected candidate.

6. The method of claim 1, wherein the step of paying is conducted before learning the personal identity of the selected candidate.

7. The method of claim 1, wherein the payment to the selected candidate is free of employment taxes.

8. The method of claim 1 further comprising the step of authenticating that the selected candidate is actually the person uniquely identified by data in the knowledge-base.

9. The method of claim 1 further comprising the step of receiving results of each atomic unit of work from the selected candidate via the Internet.

10. The method of claim 1 further comprising the step of receiving results of each atomic unit of work from the selected candidate via a human-centric trusted computing environment that uses the Internet as the transmission medium.

11. The method of claim 10 further comprising the step of continuously verifying with biometric data that each transmission via the trusted computing environment was actually made by the selected candidate.

12. The method of claim 11 further comprising the step of correlating different biometric data with an established ability to perform at least one type of atomic unit of work.

13. The method of claim 1 further comprising the step of training the selected candidate to perform at least one type of atomic unit of work.

14. The method of claim 13 further comprising the step of testing the selected candidate to determine whether the selected candidate can perform the at least one type of atomic unit of work.

15. The method of claim 1 further comprising the step of re-identifying a type of atomic unit of work that can be performed by persons with specialized training to meet an objective criterion claims 16-20. (canceled)
